(19) United States
(12) Patent Application Publication
(10) Pub. No.: US 2003/0213811 A1
(43) Pub. Date: Nov. 20, 2003

(54) Methods, devices, and systems for distributing liquids

(75) Inventor: Donald Paul Gertzman, Parkland, FL (US)

Correspondence Address: FULBRIGHT & JAWORSKI L.L.P., 600 CONGRESS AVENUE, SUITE 2400, AUSTIN, TX, 78701-3271, US

(73) Assignee: Arby's Brands, L.L.C.

(21) Appl. No.: 10/410,585

(22) Filed: Apr. 9, 2003

Related U.S. Application Data
(60) Provisional application No. 60/371,071, filed on Apr. 9, 2002.

(51) Int. Cl. G01F 11/00

(52) U.S. Cl. 222/1

(57) ABSTRACT

Apparatuses and methods for distributing liquids within a chamber of a beverage dispensing device are disclosed. The apparatuses and methods can reduce foaming of the liquid in the chamber of the beverage dispensing device.

The present application claims priority to co-pending provisional U.S. Application Serial No. 60/371,071 filed Apr. 9, 2002. The entire text of this provisional application is incorporated by reference.

### BACKGROUND OF THE INVENTION

1. Field of the Invention

The invention relates generally to liquid distribution. More specifically, the invention relates to distributing liquids within a chamber of a beverage dispensing device in a way that reduces foaming within the chamber or other parts of the beverage dispensing device.

2. Description of Related Art

Beverage dispensing devices have a chamber, or compartment, where the liquid to be served to customers is stored. This chamber is sometimes called a bowl. The liquid to be dispensed enters the bowl through an inlet tube. The tube is often oriented vertically within the bowl, with an open end near the lid of the bowl. As the liquid to ultimately be served enters the bowl through the inlet tube, the liquid is often sprayed against the lid of the bowl. In such cases, the liquid may bounce off the lid of the bowl, and hit one or more of the sides of the bowl (the bowl, of course, may be rectangular, cylindrical, round, or any other suitable shape). The process of hitting the lid of the bowl and/or hitting other sides of the bowl after hitting the lid tends to cause the liquid to foam. This is especially true of dairy products, but may also be true of fruit juices, teas, and other beverages. The foam can reduce the amount of liquid that can be stored in the bowl at any one time, and may cause problems with keeping the bowl, and consequently the beverage dispenser, clean.

### SUMMARY OF THE INVENTION

The present devices, systems, and methods reduce or eliminate the foaming described above. The present devices include an attachment, or apparatus, that may be connected to the inlet tube of any standard beverage dispensing device. The devices include a main body configured with an inlet opening for receiving the inlet tube, and two or more outlet openings for distributing liquid, or product. The outlet openings may be provided on branches or pieces that are angled both relative to horizontal and/or to a main axis extending through the main body. The present devices may be formed from multiple interconnected parts, or may be formed from a single piece of material. The present systems include the present devices connected to beverage dispensing devices. The present methods include dispensing liquid through two or more outlet openings of the present devices substantially simultaneously into a chamber within a beverage dispenser, such that foaming of the liquid within the chamber is minimized.

### BRIEF DESCRIPTION OF THE DRAWINGS

The following drawings form part of the specification and are included to further demonstrate certain aspects of the invention. The invention may be better understood by reference to one or more of these drawings in combination with the description of illustrative embodiments below. These drawings illustrate by way of example and not limitation, and they use like references to indicate similar elements. The drawings include:

FIG. 1 is a picture of a beverage dispensing device.

FIG. 2 is an exploded view of a beverage dispensing device.

FIG. 3 is a front view of one embodiment of the present devices.

FIG. 4 is a bottom view of one embodiment of the present devices.

FIG. 5 depicts one embodiment of the present devices attached to a beverage dispensing device.

FIG. 6 is a top view of one embodiment of the present devices.

FIG. 7 is a right side view of one embodiment of the present devices.

FIG. 8 shows suitable dimensions for one embodiment of the present devices.

FIG. 9 is another top view of one embodiment of the present devices.

### DESCRIPTION OF ILLUSTRATIVE EMBODIMENTS

The present device, systems, and methods and the various features and advantageous details associated with them are explained more fully with reference to the nonlimiting embodiments that are illustrated in the accompanying drawings and described in the following description. Descriptions of certain well known components and techniques are omitted so as not to obscure the present devices, systems, and methods in unnecessary detail.

Some beverage dispensers with which the present devices may be used include all versions of Grindmaster Cratcho Systems, Inc.'s Mini, Standard, Heated and Whipper Models D15, D25, and D35.

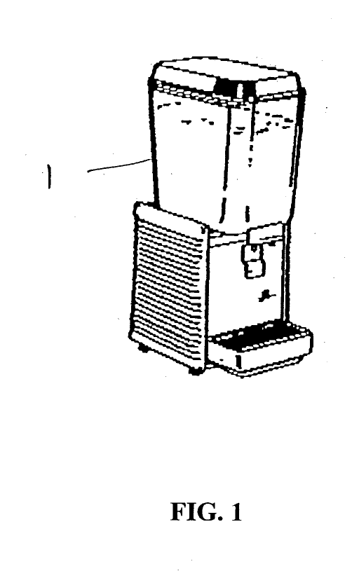

FIG. 1 depicts one of Grindmaster Cratcho Systems, Inc.'s beverage dispensers with which the present devices may be used. Element 1 depicts the bowl, which is simply a chamber into which the liquid to be dispensed is introduced and from which that liquid is later extracted for serving to customers or others. The inlet tube through which the beverage is introduced into bowl 1 is not visible through the liquid that is the bowl.

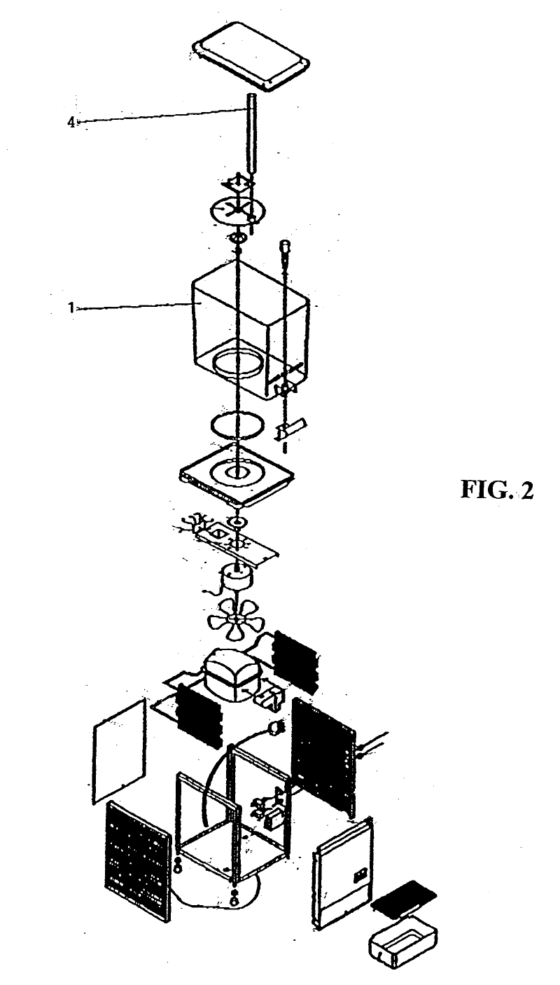

FIG. 2 shows an exploded view of one of Grindmaster Cratcho Systems, Inc.'s beverage dispensers with which the present devices may be used. This picture was taken from one of Grindmaster Cratcho Systems, Inc.'s catalogs. Element 4 is an inlet tube that delivers liquid into the chamber 1.

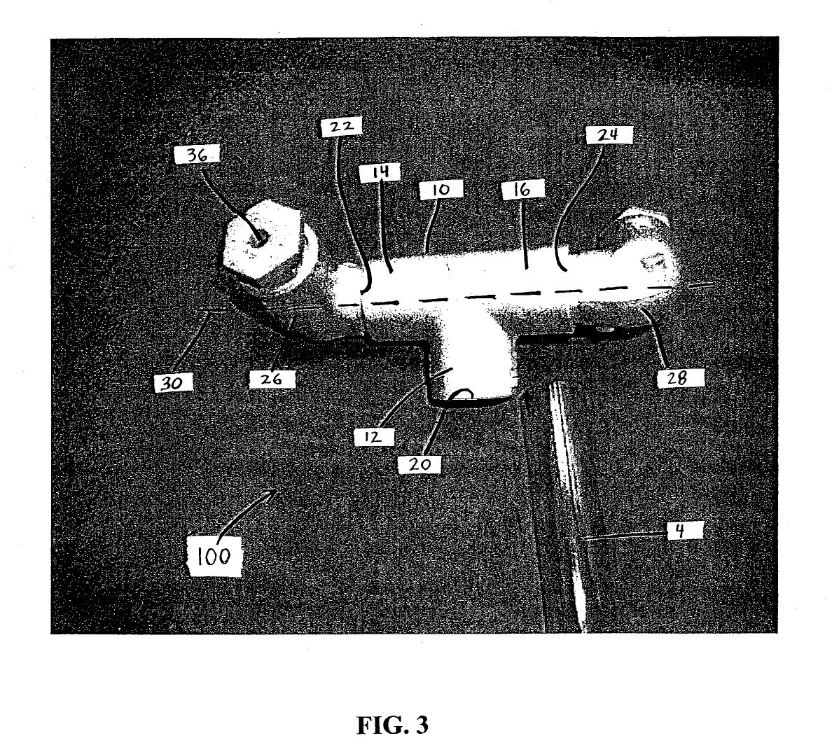

FIGS. 3-5 are photographs depicting various views of a prototype of the present devices. FIG. 3 shows device 100 positioned next to inlet tube 4. Device 100 includes main body 10. As shown, main body 10 may be configured in a T-shape. As such, main body 10 may include main arm 12 and branch arms 14 and 16, each oriented at right angles to main arm 12. Main arm 12 and branch arms 14 and 16 all communicate with one another because main body 10 is hollow.

Continuing with FIG. 3, main arm 12 of main body 10 includes inlet opening 20 configured to receive inlet tube 4. Branch arms 14 and 16 include first and second branch arm openings 22 and 24, respectively. First and second branch arm openings 22 and 24 are configured to receive dispensing connector pieces 26 and 28, respectively. Dispensing connector pieces 20 and 22 may be equipped with male ends configured for mating with female first and second branch arm openings 22 and 24. Alternatively, first and second branch arm openings 22 and 24 may be configured with male ends, and dispensing connector pieces 26 and 28 configured with female ends. This versatility is true of all of the present connections. That is, depending on the application and the best manner of constructing the present devices and systems so as, for example, to maintain the connection and reduce unwanted product build-up, a given connection may be configured with either piece making up the connection having a male fitting.

Still continuing with FIG. 3, dispensing connector pieces 26 and 28 may be configured with outlet openings. Outlet opening 36 of dispensing connector piece 26 is shown. A comparable outlet opening may be provided on dispensing connector piece 28, although not visible in FIG. 3.

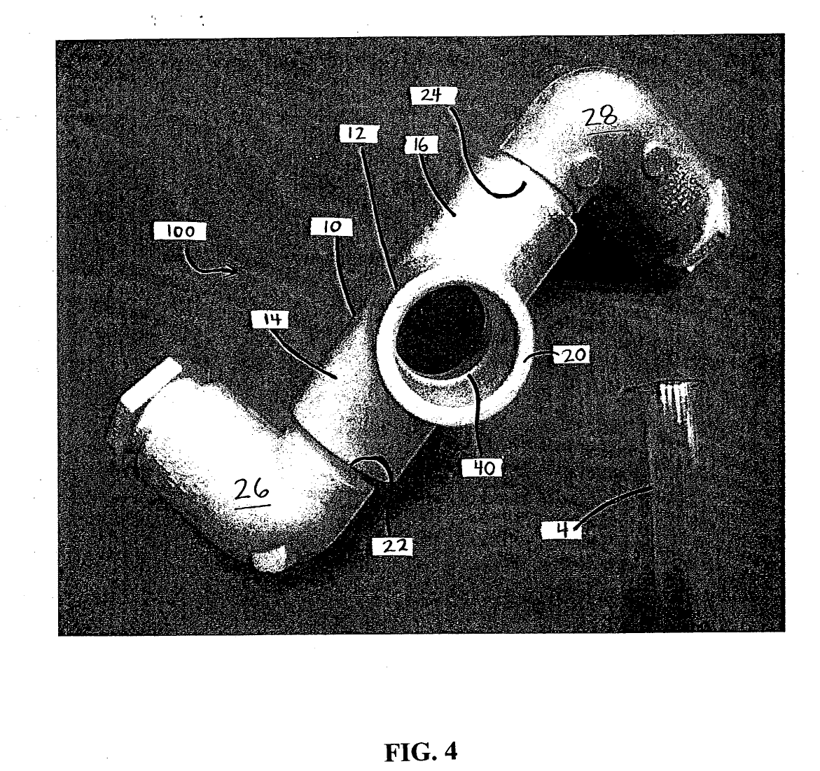

FIG. 4 is a perspective view showing substantially the bottom of device 100. FIG. 4 shows that main arm 12 of main body 10 may be provided with a shoulder 40 extending inwardly into the passageway created by main arm 12. Shoulder 40 may come to rest against the top of inlet tube 4, allowing device 100 to stay in place by the force of gravity.

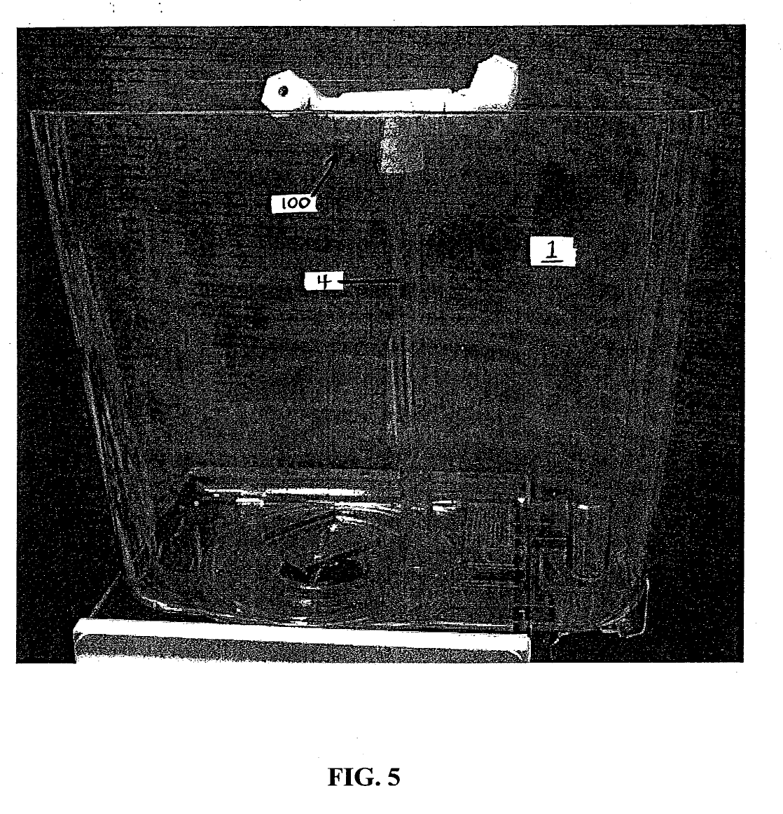

FIG. 5 shows an example of one of the present systems, which includes an embodiment of device 100 attached to inlet tube 4 disposed within bowl 1 of a beverage dispensing device. A lid may be placed on top of bowl 1 in operation. The attachment of the present device to the beverage dispensing device shown in FIG. 5 may be the result of gravity, as described above, or through the use of a lock, as described below.

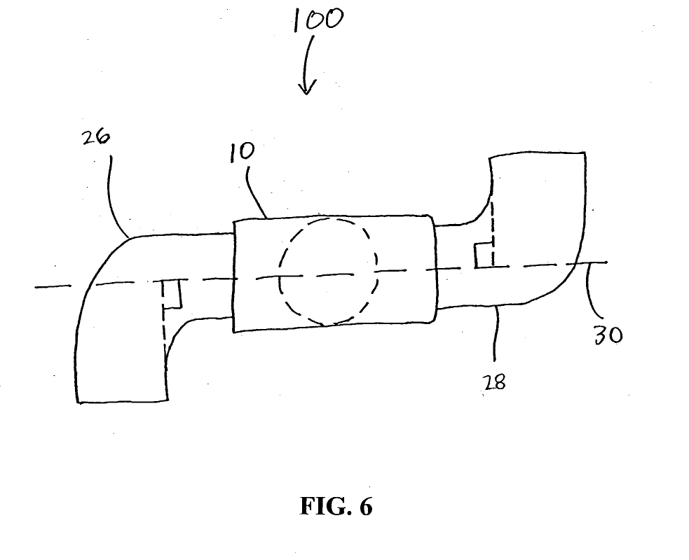

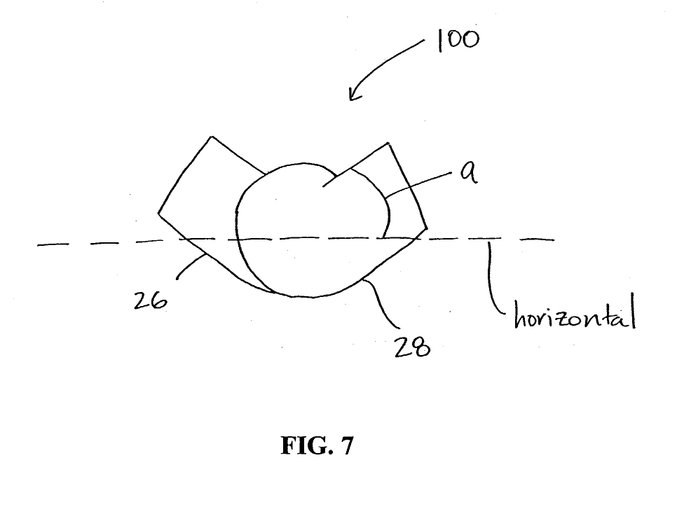

As shown in the present figures, dispensing connector pieces 26 and 28 may be angled in at least two ways. First, as shown in FIG. 6, which is a top view of device 100, dispensing connector pieces 26 and 28 may be oriented at right angles, or 90 degrees, relative to main axis 30 of device 100. Second, as shown in FIG. 7, which is a right side view of device 100, dispensing connector pieces 26 and 28 may be oriented at an angle a relative to horizontal, such that outlet openings provided in the dispensing connector pieces points upwardly to some degree. Angle a may range from 35 to 55 degrees, and may include any setting in between, and suitable settings outside the range, including 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, and 65 degrees, for example.

In operation, liquid will be introduced under pressure into bowl 1 through inlet tube 4. As the liquid exits inlet tube 1 and enters device 100, the liquid passes through main body 10 and splits into at least two streams, one stream traveling through dispensing connector piece 26 and the other stream traveling through dispensing connector piece 28. As the liquid exits the outlet openings of the dispensing connectors pieces, the present device begins to spin as the liquid is dispensed. This spinning causes the liquid to be distributed against all four walls of bowl 1 (when bowl 1 is rectangular). The spinning may also cause the liquid to be distributed evenly to all four walls of bowl 1. As a result, a pleasing visual effect of liquid, or product, cascading all four walls of bowl 1 is created. In addition, the liquid being distributed into bowl 1 does not foam as much as it does were it otherwise distributed directly out of inlet tube 4 into bowl 1. Moreover, a prototype of the present devices has been tested and found to virtually eliminate foaming in a dairy version of liquid.

While the present devices have been described in terms of devices with interconnecting parts, it will be understood that the present devices may be constructed of a single piece of material. Examples of materials that may be used to form the present devices, whether they be formed of multiple, interconnecting pieces, or a single piece, include all food grade materials. Some such materials include plastics such as lucite, plexiglas, polyethylene and PVC; and metals such as stainless steel. The plastic used may be clear.

When the present devices are formed of multiple pieces, as shown especially in FIGS. 3-5, the pieces should be designed such that they can be taken apart and cleaned. In addition, sharp comers between mating sections of the pieces should be reduced or eliminated, to reduce or eliminate the buildup of any liquid at the junctions of the pieces.

The prototype device depicted in FIGS. 3-5 was tested and found to work well at reducing and virtually eliminating foaming of a liquid dairy-based product that included whole milk, skim milk, gums, and sugar. The device was placed on, but not locked to, the inlet tube in the bowl of the dispenser. As the liquid was fed into the bowl through the prototype device, the device spun around and distributed liquid to all four walls of the bowl. A pleasing visual effect was created, which consisted of liquid cascading down all the walls of the bowl. In addition, the product did not foam to any noticeable degree as it was being distributed into the bowl. This reduction or elimination of foam helps maintain the quality of the product, and adds to the visual presentation of the product within the bowl. Furthermore, this visual enhancement translates to a merchandising and marketing enhancement for any beverage dispenser to which the present devices are added.

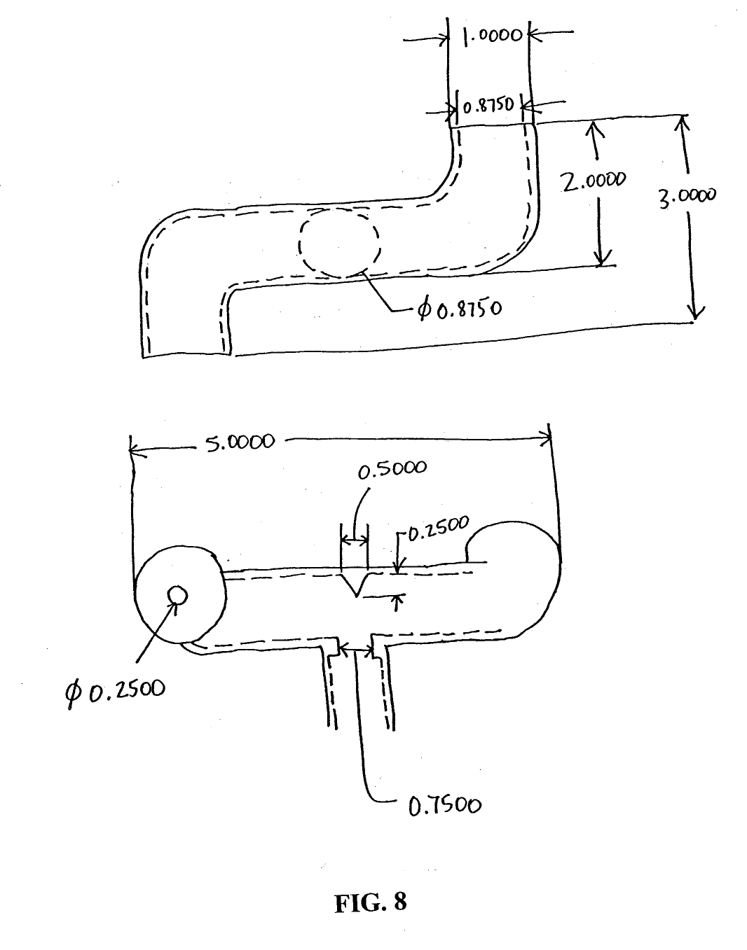

Examples of suitable dimensions for one embodiment of the present devices are shown in FIG. 8. The dotted lines shown in FIG. 8 represent the inner wall of the present devices. The main arms of the present devices may be any suitable length. In at least one embodiment of the present devices, the main arm may be eliminated.

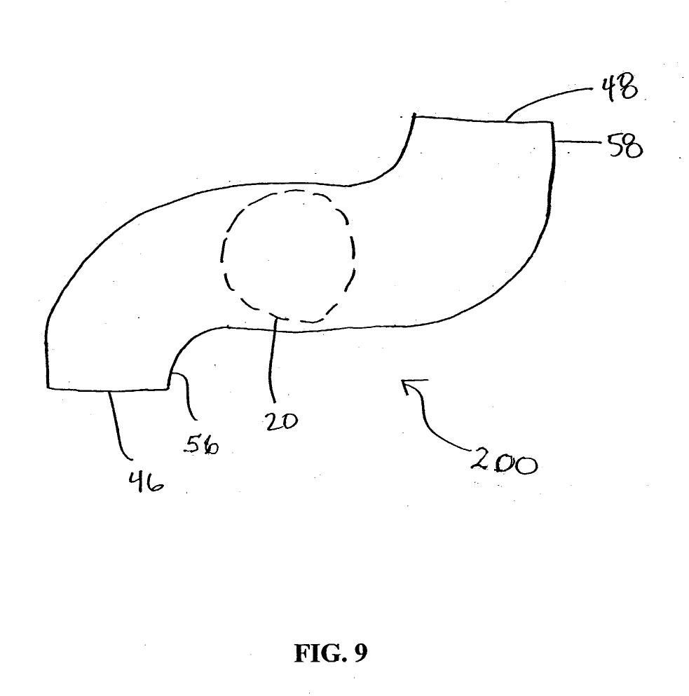

Many variations of the present devices are possible that provide for the even distribution of product to the inside of the bowl of a dispensing device. For example, device 200 shown in FIG. 9 includes a single body with inlet opening 20 configured to receive an inlet tube of a beverage dispenser, and outlet openings 46 and 48, which are disposed at the ends of dispensing branches 56 and 58, respectively. Device 200 is shown as a single piece, and the two dispensing branches, while having outlet openings configured in the same position as the outlet openings of device 100, are curved more gently then the dispensing connector pieces 26 and 28 of device 100 as seen in FIG. 6 for example. Thus, the version of the present device shown in FIG. 9 has somewhat of an S-shape.

Another variation that may be provided on the present devices is a lock for securing the present device to the inlet tube positioned in the bowl of a dispenser. The lock may consist of any structure that retains the position of the device on the inlet tube, while allowing the device to rotate during operation. One or more seals that include ball bearings may make up such a lock. In addition or in the alternative, the inside of the main arm of one embodiment of the present devices may be provided with a compressible shoulder that snaps into a corresponding groove provided in an inlet tube may be used in such a locking structure.

The diameter of the outlet opening(s) and/or the weight of the present device may vary depending on the size of the motor being used in the beverage dispensing device, the number of dispensing arms on the present device, the angle of the dispensing arms relative to the body of the device, the force of liquid coming through the inlet tube, the force of the liquid coming through the present device and/or the viscosity of the liquid to be dispensed. The weight of the present device can be light enough to allow the apparatus to rotate about the inlet tube of the liquid dispensing device but heavy enough to not fly off the inlet tube.

In other embodiments, the present device may have one, two, three, four or five outlet openings to dispense liquid into the chamber. In other aspects of the invention, the present devices may have one, two , three, four or five dispensing arms. The angle of the dispensing arm(s) can be adjusted depending on the amount of foam being produced by the liquid and/or the desired appearance of the liquid in the chamber.

We claim:

1. An apparatus for dispensing liquid comprising:
a body having:
(a) an inlet opening configured to receive a structure that is part of a beverage dispensing device such that the body can rotate about the structure;
(b) a first dispensing arm having a first outlet; and
(c) a second dispensing arm having a second outlet.

2. The apparatus of claim 1, where a portion of the first dispensing arm is oriented at a non-zero first angle relative to a portion of the body, and a portion of the second dispensing arm is oriented at a non-zero second angle relative to the portion of the body.

3. The apparatus of claim 2, where the first and second angles each range from 20-65 degrees.

4. The apparatus of claim 2, where the first and second angles each range from 35-55 degrees.

5. The apparatus of claim 1, where the liquid is dispensed in a chamber.

6. The apparatus of claim 1, where the apparatus also comprises a liquid dispensing device connected to the body.

7. The apparatus of claim 1, where the body has an arm that includes an inlet opening and a passageway connecting the inlet opening to the first outlet, and where the arm includes a shoulder extending inwardly into the passageway.

8. The apparatus of claim 1, where the first dispensing arm includes a first branch arm and a first dispensing connector piece coupled to the first dispensing arm.

9. The apparatus of claim 8, where the second dispensing arm includes a second branch arm and a second dispensing connector piece coupled to the second dispensing arm.

10. The apparatus of claim 1, where the body includes a T-shaped main body having a horizontal axis and the inlet opening.

11. The apparatus of claim 1, where the body comprises metal.

12. The apparatus of claim 1, where the body comprises plastic.

13. The apparatus of claim 1, where the body includes a lock configured to secure the apparatus to the structure in a way that allows the apparatus to rotate about the structure.

14. The apparatus of claim 1, where the inlet opening is circular shaped.

15. The apparatus of claim 1, where the body is made from a single piece of material.

16. The apparatus of claim 1, where the body includes separate pieces of material.

17. An apparatus for dispensing liquid comprising:
a body having:
(a) an inlet opening configured to receive a structure that is part of a beverage dispensing device such that the body can rotate about the structure; and
(b) a first dispensing arm having a first outlet.

18. The apparatus of claim 17, where a portion of the first dispensing arm is oriented at a non-zero first angle relative to a portion of the body.

19. The apparatus of claim 17, where the liquid is dispensed in a chamber.

20. The apparatus of claim 17, where the apparatus also comprises a liquid dispensing device connected to the body.

21. A method of dispensing liquid in a chamber comprising directing liquid into a body configured to allow the liquid to be distributed in a rotating fashion against the chamber.

22. The method of claim 21, where the chamber includes multiple sides.

23. The method of claim 21, where the body comprises:
(a) an inlet opening configured to receive a structure that is part of a beverage dispensing device such that the body can rotate about the structure;
(b) a first dispensing arm having a first outlet; and
(c) a second dispensing arm having a second outlet.

24. The method of claim 23, where a portion of the first dispensing arm is oriented at a non-zero first angle relative to a portion of the body, and a portion of the second dispensing arm is oriented at a non-zero second angle relative to the portion of the body.
